(19) United States
(12) Patent Application Publication
(10) Pub. No.: US 2005/0256714 A1
(43) Pub. Date: Nov. 17, 2005

(54) Sequential variance adaptation for reducing signal mismatching

(76) Inventors: Xiaodong Cui, Los Angeles, CA (US); Yifan Gong, Plano, TX (US)

Correspondence Address: TEXAS INSTRUMENTS INCORPORATED, P O BOX 655474, M/S 3999, DALLAS, TX, 75265, US

(21) Appl. No.: 10/811,596

(22) Filed: Mar. 29, 2004

(51) Int. Cl. G10L 15/00

(52) U.S. Cl. 704/256.4

(57) ABSTRACT

The mismatch between the distributions of acoustic models and features in speech recognition may cause performance degradation. A sequential variance adaptation (SVA) adapts the covariances dynamically based on a sequential EM algorithm. The original covariances in acoustic models are adjusted by scaling factors which are sequentially updated once new collection data is available.

### FIELD OF INVENTION

This invention relates to speech recognition and more particularly to mismatch between the distributions of acoustic models and noisy feature vectors.

### BACKGROUND OF INVENTION

In speech recognition, inevitably the recognizer has to deal with channel and background noise. The mismatch between the distributions of acoustic models (HMMs) and noisy feature vectors could cause degradation in performance of the recognizer. Model compensation is used to reduce such mismatch by modifying the acoustic models according to the certain amount of observations collected in the target environment.

Typically, batch parameter estimations are employed to update parameters after observation of all adaptation data which are not suitable to follow slow time varying environments. See L. R. Rabiner, A tutorial on hidden Markov models and selected applications in speech recognition, Proceedings of the IEEE. 77(2): 257-285, February 1989. Also see C. J. Leggetter and P. C. Woodland, Speaker adaptation using linear regression, Technical Report F-INFENG/TR. 181, CUED, June 1994.

In recognizing speech signal in a noisy environment, the background noise causes the speech variance to shrink as noise intensity increases. See D. Mansour and B. H. Juang, A family of distortion measures based upon projection operation for robust speech recognition, IEEE Transactions on Acoustic, Speech and Signal Processing, ASSP-37(11):1659-1671, 1989.

Such statistic variation must be corrected in order to preserve recognition accuracy. Some methods adapt variance for speech recognition but they require an estimation of noise statistics to be provided. See M. J. Gales, PMC for Speech recognition in additive and convolutional noise, Technical Report TR-154, CUED/F-INFENG, December 1993.

### SUMMARY OF INVENTION

In accordance with one embodiment of the present invention a method of updating covariance of a signal in a sequential manner includes the steps of scaling the covariance of the signals by a scaling factor; updating the scaling factor based on the signal to be recognized; updating the scaling matrix each time new data of the signal is available; and calculating a new scaling factor by adding a correction item to a previous scaling factor.

In accordance with an embodiment of the present invention sequential variance adaptation (SVA) adapts the covariances of the acoustic models online sequentially based on the sequential EM (Estimation Maximization) algorithm. The original covariances in the acoustic models are scaled by a scaling factor which is updated based on the new speech observations using stochastic approximations.

### DESCRIPTION OF DRAWING

FIG. 1 illustrates prior art speech recognition system.

FIG. 2 illustrates the variance in a clean environment.

FIG. 3 illustrates the variance for a noisy environment.

FIG. 4 illustrates a speech recognition system according to one embodiment of the present invention.

### DESCRIPTION OF PREFERRED EMBODIMENTS OF THE PRESENT INVENTION

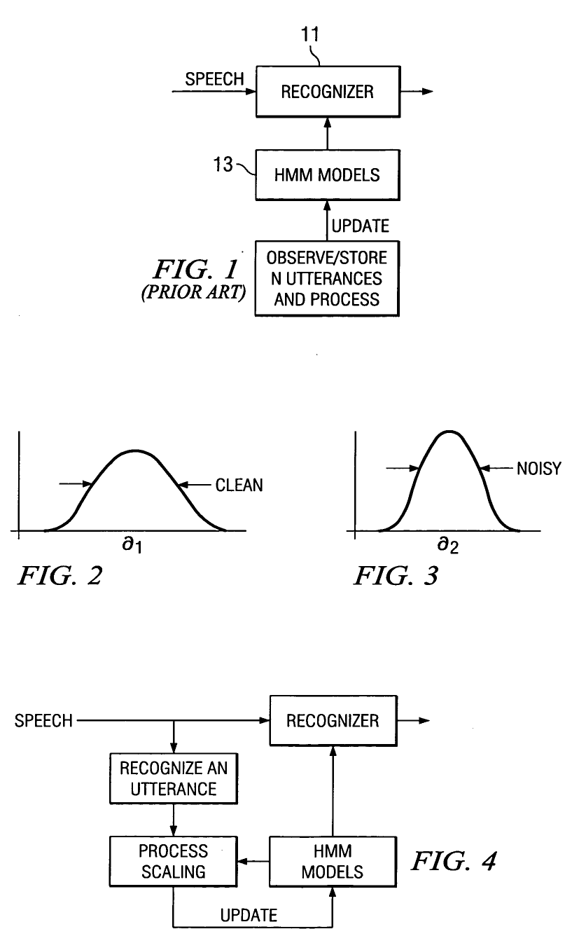

A speech recognizer as illustrated in FIG. 1 includes speech models 11 and speech recognition is achieved by comparing the incoming speech at a recognizer 13 to the speech models such as Hidden Markov Models (HMMs) models. This invention is about an improved model used for speech recognition. In the traditional model the distribution of the signal is modeled by a Gaussian distribution defined by μ and Σ where μ is the mean and Σ is the variance. The observed signal Oₜ is defined by observation N (μ, Σ).

FIG. 2 illustrates the variance in a clean environment. FIG. 3 illustrates the variance for a noisy environment. The variance is much narrower in a noisy environment. What is needed is to fix the variance to be more like the clean environment.

The mismatch between the distributions of acoustic models (HMMs) and feature vectors in speech recognition may cause performance degradation which could be improved by model compensation. Typically, batch parameter estimations are employed for model compensation where parameters are updated after observation of all adaptation data. Parameters updated this way are not suitable for follow slow parameter changes often encountered in speech recognition. Applicants' propose sequential variance adaptation (SVA) that adapts the covariances dynamically based on the sequential EM algorithm. The original covariances in acoustic models are adjusted by scaling matrices which are sequentially updated once new collection of data is available. SVA is able to obtain better estimation of time-varying model parameters to achieve good performance.

The following equation (1) is the performance index or Q function. The Q function is a function of θ which includes this bias.

$${Q}_{K + 1}^{( 5 )} ( {Θ}_{k} , θ ) = {\sum }_{γ = 1}^{K + 1} {Q}_{γ} ( {Θ}_{k} , θ ) \qquad ( 1 )$$

where

$${Q}_{k = 1}^{( 5 )}$$

denotes the EM auxiliary Q-function based on all the utterances from 1 to k+1, in which is the parameter set at utterance k and θ denotes a new parameter set. See A. P. Dempster, N. M. Laird, and D. B. Rubin “Maximum likelihood from incomplete data via the EM algorithm. Journal of the Royal Statistical Society, 39(1):1-38, 1977.

$${Q}_{k = 1}^{( 5 )}$$

can be written in a recursive way as:

$${Q}_{k + 1}^{( 5 )} ( {Θ}_{k} , θ ) = {Q}_{k}^{( 5 )} ( {Θ}_{k - 1} , θ ) + {Q}_{k + 1} ( {Θ}_{k} , θ ) , \qquad ( 2 )$$

where

$${}^{{Q}_{k = 1}^{( 5 )}} ( {Θ}_{k} , θ )$$

is the Q-function for the (k+1)th utterance. Based on stochastic approximation, sequential updating is

$${θ}_{k + 1} = {θ}_{k} - {{[ \frac{\partial {}_{}^{2}{Q}{}_{k + 1}^{( 5 )} ( {Θ}_{k} , θ )}{{\partial }^{2} θ} ]}_{θ = {θ}_{k}}^{- 1} [ \frac{\partial {l}_{k + 1} ( {Θ}_{k} , θ ) ,}{\partial θ} ]}_{θ = {θ}_{k}} \qquad ( 3 )$$

Suppose the state observation power density functions (pdfs) are Gaussian mixtures with each Gaussian defined as equation 4.

$${b}_{jm} ( {o}_{i} ) = N ( {o}_{i} ; {μ}_{jm} , {Σ}_{jm} ) = \frac{1}{{( 2 π )}^{\frac{π}{2}} {\vert {Σ}_{jm}^{- 1} \vert}^{\frac{1}{2}}} {ⅇ}^{\frac{1}{2} {( {o}_{i} - {μ}_{jm} - {I}_{i} )}^{T} {Σ}_{jm}^{- 1} ( {o}_{i} - {μ}_{jm} )} \qquad ( 4 )$$

where the covariance matrix Σⱼₘ is assumed to be diagonal which implies the independence of each dimension of the feature vectors.

Since the components of feature vectors are assumed to be independent, the formulation on the sequential estimation algorithm is carried out using single variable for each dimension. The Gaussian pdf for the pth dimension in state j mixture m is

$${b}_{jmp} ( {o}_{i , p} ) = N ( {o}_{i , p} ; {μ}_{jmp} , {σ}_{jmp}^{2} ) = \frac{1}{\sqrt{2 π} \sqrt{{ⅇ}^{{ρ}_{p}} {σ}_{jmp}^{2}}} {ⅇ}^{- \frac{{( {o}_{i , p} - {μ}_{jmp} )}^{2}}{2 {ⅇ}^{{ρ}_{P} {σ}_{jmp}^{2}}}} \qquad ( 5 )$$

where the variance scaling factor e^{Pp} takes an exponential form to guarantee the positiveness of the updated variances. The typical variance is σ²ⱼₘₚ. We introduce e^{Pp}. ρ is a scalar number.

Also, to obtain reliable estimate, ρ's are tied for all phoneme HMMs for each dimension. But the derivation of ρ under alternate tying schemes is also straightforward. By computing the value of e^{Pp} we can modulate the variance of any distribution. If this e^{Pp} is larger you make the variance larger. We then try to optimally modify ρ so that we can find the best variance for the system.

Applying equation 3 with

$${Q}_{k + 1} ( {Θ}_{k} , {ρ}_{p} ) = {\sum }_{j} {\sum }_{m} {\sum }_{p} {{\sum }^{{T}^{k + i}}}_{i = 1} {γ}_{k + 1 , i} ( j , m ) log {b}_{jmp} ( {o}_{i , p} ) = {\sum }_{j} {\sum }_{m} {\sum }_{p} {{\sum }^{{T}^{k + i}}}_{i = 1} {γ}_{k + 1 , i} ( j , m ) [ - \frac{1}{2} log 2 π - \frac{1}{2} {ρ}_{p} - \frac{1}{2} log {σ}_{jmp}^{2} - \frac{{( {o}_{i , p} - {μ}_{jmp} )}^{2}}{2 {ⅇ}^{{ρ}_{P} {σ}_{jmp}^{2}}} ] \qquad ( 6 )$$

where γ_{k+1,t}(j,m)=P(ηₜ=j,εₜ=m|oₗ^{T+1}, Θₖ) is the probability that the system stays at time t in state j mixture m given the observation sequence oₗ^{Tk+1}, we get for second and first derivative

$$\frac{\partial {Q}_{k + 1} ( {Θ}_{k} , {ρ}_{p} )}{\partial {ρ}_{p}} = {\sum }_{j} {\sum }_{m} {{\sum }^{{T}^{k + i}}}_{i = 1} {γ}_{k + 1 , i} ( j , m ) [ - \frac{1}{2} + \frac{{( {o}_{i , p} - {μ}_{jmp} )}^{2}}{2 {ⅇ}^{{ρ}_{P} {σ}_{jmp}^{2}}} ] \qquad ( 7 )$$

$$\frac{{\partial }^{2} {Q}_{k + 1} ( Θ \text{?} , ρ \text{?} )}{\partial {ρ}^{2} \text{?}} = - {\sum }_{j} \sum \text{?} {\sum \text{?}}_{t = 1} {γ}_{k + 1 , t} ( j , m ) \frac{{( o \text{?} , \text{?} - {μ}_{j} \text{?} )}^{2}}{2 {ⅇ}^{ρ} {\text{?}}^{{ρ}^{2}} \text{?}} \\ \text{?} \text{indicates text missing or illegible when filed} \qquad ( 8 )$$

and the sequential updating equation is finding older ρ plus adjustment quantity as

$${ρ}_{\text{?}}^{( k + 1 )} \text{?} = {ρ}_{\text{?}}^{( k )} \text{?} + {[ {\sum }_{j} \sum \text{?} {\sum }_{t = 1} \text{?} {γ}_{k + 1 , t} ( j , m ) \frac{{( o \text{?} , \text{?} - {μ}_{j} \text{?} \text{?} )}^{2}}{2 {ⅇ}^{{ρ}_{{\text{?}}^{{σ}_{\text{?}}^{2}} \text{?}}}} ]}^{- 1} [ {\sum }_{j} \sum \text{?} {\sum }_{t = 1} \text{?} {γ}_{k + 1 , t} ( j , m ) [ \frac{1}{2} + \frac{{( o \text{?} , \text{?} - {μ}_{j} \text{?} \text{?} )}^{2}}{2 {ⅇ}^{{ρ}_{{\text{?}}^{{σ}_{\text{?}}^{2}} \text{?}}}} ] ] \\ \text{?} \text{indicates text missing or illegible when filed} \qquad ( 9 )$$

The above equation 9 states that the updated scaling factor is the current scaling factor plus a correction, which is a product of two factors.

After every utterance an update is done so that it is sequential. As illustrated in FIG. 4 the steps according to the present invention are an utterance is recognized, the variance is adjusted using the utterance and then the model is updated. The updated model is used in the recognition of the next utterance and the variance is adjusted using the previously updated value plus the new adjustment quantity. The model is then updated.

The method of updating covariance of a signal in a sequential manner is disclosed wherein the covariance of the signal is scaled by a scaling factor. The scaling factor is updated based on the signal to be recognized. No additional data collection is necessary. The scaling factor is updated each time new data of the signal is available. The new scaling factor is calculated by adding a correction item to the old scaling factor. The scaling factor can be a matrix. The scaling matrix could be any matrix that ensures the scaled matrix a valid covariance. The new available data could be based on any length, in particular, it could be frames, utterances or every 10 minutes of a speech signal. The correction is the product of any sequences whose limit is zero, whose summation is infinity and whose square summation is not infinity and a summation of quantities weighted by a probability.

1. A method of updating covariance of a signal in a sequential manner comprising the steps of:
scaling the covariance of the signals by a scaling factor;
updating the scaling factor based on the signal to be recognized;
updating the scaling matrix each time new data of the signal is available; and
calculating a new scaling factor by adding a correction item to a previous scaling factor.

2. The method of claim 1 wherein the signal comprises a speech signal.

3. The method of claim 1 wherein the scaling factor is a scaling matrix and could be any matrix that ensures the scaled matrix is a valid covariance.

4. The method of claim 1 wherein the new available data of the signals could be based on any length.

5. The method of claim 1 wherein the new available data of the signals could be a frame.

6. The method of claim 1 wherein the new available data of the signals could be an utterance.

7. The method of claim 1 wherein the new available data of the signals could be a fixed time period.

8. The method of claim 1 wherein the new available data could be every 10 minutes of a speech signal.

9. The correction of claim 1 wherein the correction is the product of any sequence whose limit is zero, whose summation is infinity and whose square summation is not infinity and a summation of quantities weighted by a probability.
